(19) United States
(12) Patent Application Publication
(10) Pub. No.: US 2020/0005621 A1
(43) Pub. Date: Jan. 2, 2020

(54) LIQUID LEVEL ALARM DEVICE FOR WATER FILTER

(71) Applicant: GUANGDONG BOYU GROUP CO., LTD, Chaozhou City (CN)

(72) Inventors: Youkai Yu, Chaozhou City (CN); Bingyan YU, Chaozhou City (CN); Jianqin YU, Chaozhou City (CN)

(73) Assignee: GUANGDONG BOYU GROUP CO.,LTD, Chaozhou City (CN)

(21) Appl. No.: 16/452,080

(22) Filed: Jun. 25, 2019

(30) Foreign Application Priority Data
Jun. 27, 2018 (CN) 201820998341.6

(51) Int. Cl. G08B 21/18; G01F 23/26; G01F 23/62; C02F 1/00

(52) U.S. Cl. CPC G08B 21/182; G01F 23/261; C02F 2103/007; C02F 1/001; G01F 23/62

(57) ABSTRACT

Provided is a liquid level alarm device for a water filter including an alarm assembly and a liquid level detecting device. The liquid level detecting device is electrically connected to the alarm assembly and arranged in a water tank of the water filter. The alarm assembly is arranged on the water tank. The liquid level detecting device is configured to, in condition that a liquid level in the water tank rises to a preset height, send a liquid level warning signal to drive the alarm assembly to send an alarm signal. By arranging the liquid level detecting device in the water tank of the water filter, the liquid level in the water tank is detected by the liquid level detecting device. When the liquid level in the water tank of the water filter reaches the preset height, the liquid level detecting device sends a driving signal to drive the alarm assembly to send an audible and visual alarm signal. When seeing or hearing the audible and visual alarm signal, the user can know that the filter element of the water filter is blocked and fails to operate normally.

### CROSS-REFERENCES TO RELATED APPLICATIONS

This application claims priority to Chinese patent application No. 201820998341.6 filed on Jun. 27, 2018 disclosure of which is incorporated herein by reference in its entirety.

### TECHNICAL FIELD

The present disclosure relates to the technical field of water filter, for example, a liquid level alarm device for a water filter.

### BACKGROUND

In the places for aquaculture, such as an aquarium or a garden pond, a water filter is usually arranged to purify the impurities in water during the aquaculture process, so as to ensure that the water quality of the aquaculture water is suitable for the healthy growth of fishes. The existing water filter is usually provided with a porous filter material to filter the water drawn into the water filter, and then transports the filtered water to the places for aquaculture, such as the aquarium or the garden pond, so as to ensure the health of water quality of aquaculture.

However, after the water filter is utilized for a period of time, the dirt in water is accumulated in the pores of the filter material to cause clogging. When the dirt is accumulated to a certain degree, the resistance of the water flow increases, which causes the liquid level in the water filter to rise, thus causes the filtration function of the water filter to be failed, and even the water to spread out to cause short-circuit damage of devices such as the water filter. Moreover, the existing water filter does not have an alarm device to remind the user to replace the filter material in time.

### SUMMARY

Provided is a liquid level alarm device for a water filter, which is capable of sending a reminder of replacing a filter element when a liquid level of the water filter reaches a preset value.

A liquid level alarm device for a water filter according to one embodiment includes an alarm assembly and a liquid level detecting device.

The alarm assembly is electrically connected to the liquid level detecting device arranged in a water tank of the water filter. The alarm assembly is arranged on the water tank. The liquid level detecting device is configured to, in condition that a liquid level in the water tank rises to a preset height, send a liquid level warning signal to drive the alarm device to send an alarm signal.

In one embodiment, the liquid level detecting device includes a first electrode and a second electrode. The second electrode is arranged at a warning liquid level of the water tank. The first electrode is arranged on a position of the water tank not lower than the second electrode. The first electrode and the second electrode are electrically connected to a power source and the alarm assembly, respectively. In condition that the liquid level in the water tank reaches the warning liquid level, the first electrode and the second electrode are both in contact with water and conductive to drive the alarm assembly to send the alarm signal.

In one embodiment, the liquid level detecting device includes a floating body structure having a magnetic property and a magnetic detecting device. The floating body structure is arranged in the water tank. The magnetic detecting device is correspondingly arranged at a warning liquid level. The magnetic detecting device is configured to, when the liquid level in the water tank reaches the warning liquid level, detect a magnetic signal of the floating body structure and drive the alarm assembly to send the alarm signal.

In one embodiment, the floating body structure further includes a guiding structure for limiting the floating body structure to move along the vertical direction.

In one embodiment, the guiding structure includes a guiding rod fixedly arranged in the water tank, and a guiding hole corresponding to the guiding rod and arranged on the floating body structure. The guiding rod and the guiding hole are arranged along the vertical direction. The floating body structure is sleeved on the guiding rod.

In one embodiment, the guiding structure includes a guiding rail assembly and a guiding groove assembly which are fixedly arranged on the water tank and the floating body structure respectively. The guiding rail assembly and the guiding groove assembly are arranged along the vertical direction. The guiding rail assembly and the guiding groove assembly are cooperated each other to limit the floating body structure to move along the vertical direction.

In one embodiment, the guiding structure includes a guiding tube fixedly arranged in the water tank along the vertical direction, the floating body structure is arranged in the guiding tube.

In one embodiment, the liquid level detecting device is an ultrasonic ranging sensor, a light ranging sensor or a pressure sensor.

In one embodiment, a permanent magnet is arranged on a surface or inside of the floating body structure.

In one embodiment, the magnetic detecting device is a Hall sensor or a reed switch.

The beneficial effect of the present disclosure is as follows. By arranging the liquid level detecting device in the water tank of the water filter, the liquid level in the water tank is detected by the liquid level detecting device. When the liquid level in the water tank of the water filter reaches the preset height, the liquid level detecting device sends a driving signal to drive the alarm assembly to send an audible and visual alarm signal. When seeing or hearing the audible and visual alarm signal, the user can know that the filter element of the water filter is blocked and fails to operate normally.

### BRIEF DESCRIPTION OF DRAWINGS

FIG. 1 is a schematic perspective view of a water filter according to one embodiment.

FIG. 2 is a sectional view of a water filter according to one embodiment.

FIG. 3 is a circuit diagram of a liquid level alarm device for a water filter according to one embodiment.

FIG. 4 is a circuit diagram of a liquid level alarm device for a water filter according to another embodiment.

FIG. 5 is a circuit diagram of a liquid level alarm device for a water filter according to another embodiment.

### IN THE DRAWINGS

1—water filter; 11—water tank;

2—liquid level detecting device; 21—first electrode; 22—second electrode; 23—floating body structure; 24—magnetic detecting device;

3—alarm assembly.

### DETAILED DESCRIPTION

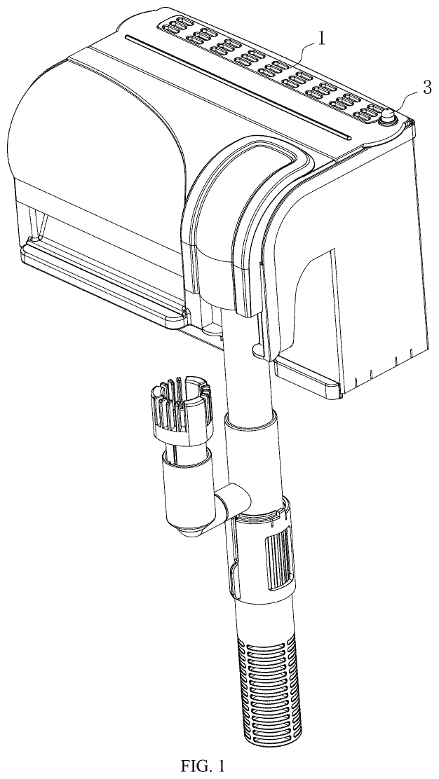

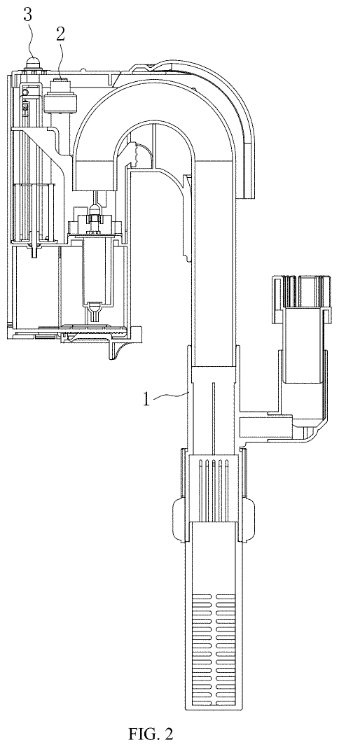

As shown in FIG. 1 to FIG. 5, a liquid level alarm device for a water filter according to the embodiments of the present disclosure includes an alarm assembly 3. When a liquid level in a water tank 11 of the water filter 1 rises to a preset height, the alarm assembly 3 is configured to alert the user in time, so that the user can be informed in time that a filter element of the water filter 1 is blocked and fails to operate normally, so that the user can replace the filter element of the water filter 1 in time, so that the normal filtration of the water filter 1 is ensured.

The alarm assembly 3 of the liquid level alarm device for the water filter may be configured as an electronic automatic alarm structure. As shown in FIG. 1 to FIG. 5, in the present embodiment, the liquid level alarm device for the water filter of the present disclosure is arranged in the water filter 1, and includes a liquid level detecting device 2 and an alarm assembly 3. The liquid level detecting device 2 is arranged in a water tank 11 of the water filter 1. The liquid level detecting device 2 is electrically connected to the alarm assembly 3. The alarm assembly 3 is arranged on the water tank 11 of the water filter 1. The liquid level detecting device 2 is configured to, when a liquid level in the water tank 11 is at a preset height, send a liquid level warning signal to drive the alarm assembly 3 to send an alarm signal.

By arranging the liquid level detecting device 2 in the water tank 11 of the water filter 1, the liquid level in the water tank 11 is detected by the liquid level detecting device 2. When the liquid level in the water tank 11 of the water filter 1 reaches the preset height, the liquid level detecting device 2 sends a driving signal to drive the alarm assembly 3 to send an audible and visual alarm signal. When seeing or hearing the audible and visual alarm signal, the user can know that the filter element of the water filter 1 is blocked and fails to operate normally, thereby realizing automatic monitoring on the liquid level in the water tank 11 of the water filter 1. The operation is easy, and it can be known that the filter element is blocked and fails to operate normally at this moment, without opening the water tank 11 or waiting water in the water tank 11 to overflow.

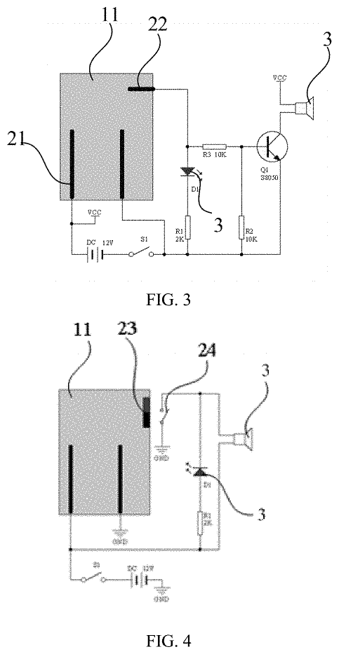

As shown in FIG. 3, in one specific embodiment of the present disclosure, the liquid level detecting device 2 includes a first electrode 21 and a second electrode 22. The second electrode 22 is arranged at the preset height of the water tank 11. The first electrode 21 is arranged on a position of the water tank 11 not lower than the second electrode 22. The first electrode 21 and the second electrode 22 are electrically connected to a power source and the alarm assembly 3, respectively. When the liquid level in the water tank 11 reaches the preset height, the first electrode 21 and the second electrode 22 are in contact with the water and conductive to drive the alarm assembly 3 to send the alarm signal.

By arranging two electrodes in the water tank 11 of the water filter 1, when the liquid level rises to immerse two electrodes, two electrodes are connected to form a complete circuit, further driving the alarm assembly 3 to send the alarm signal.

Optionally, a third electrode is arranged in the water tank 11. The first electrode 21 and the third electrode are respectively connected to the positive electrode and the negative electrode of the power source. By arranging the third electrode connected with first electrode 21 to form the circuit, part of water in the water tank 11 is electrolyzed, to enhance the conductivity of the water, which makes the conduction between the first electrode 21 and the second electrode 22 easier.

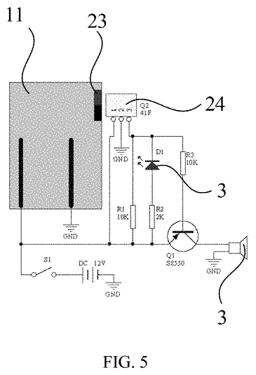

As shown in FIG. 4 to FIG. 5, in another embodiment of the present disclosure, the liquid level detecting device 2 includes a second floating body structure 23 having a magnetic property and a magnetic detecting device 24. The floating body structure 23 is arranged in the water tank 11. The magnetic detecting device 24 is arranged at the preset height of the water tank 11. The magnetic detecting device 24 is configured to, when the liquid level in the water tank 11 reaches the preset height, detect a magnetic signal of the floating body structure 23 and drive the alarm assembly 3 to send the alarm signal. By arranging a floating body structure 23 with magnetic property and the magnetic detecting device 24 cooperated with the floating body structure 23 in the water tank 11, the automatic monitoring on the liquid level is realized.

Optionally, the floating body structure 23 further includes a guiding structure for limiting the floating body structure 23 to move along a vertical direction. By arranging a guiding structure in the water tank 11 to limit the movement of the floating body structure 23, it ensures that the movement trajectory of the floating body structure 23 in the water tank 11 is determined, thereby ensuring that the floating body structure 23 is within a detecting range of the magnetic detecting device 24 every time the liquid level rises.

In one embodiment, the guiding structure includes a guiding rod fixedly arranged in the water tank 11 of the water filter 1, and a guiding hole corresponding to the guiding rod and arranged on the floating body structure 23. The guiding rod and the guiding hole are arranged along the vertical direction. The floating body structure 23 is sleeved on the guiding rod.

In other embodiments, the guiding structure includes a guiding rail assembly and a guiding groove assembly which are fixedly arranged on the water tank 11 of the water filter 1 and the floating body structure 23, respectively. The guiding rail assembly and the guiding groove assembly are arranged along the vertical direction. The guiding rail assembly and the guiding groove assembly are cooperated each other to limit the floating body structure 23 to move along the vertical direction.

Optionally, the guiding structure may be a guiding tube fixedly arranged in the water tank 11 of the water filter 1 along the vertical direction. The floating body structure 23 is arranged in the guiding tube. The guiding tube is provided with one or more vent holes for venting the air in the guiding tube so that the air pressure in the guiding tube is equal to the air pressure in the water tank 11 of the water filter 1.

By arranging the guiding structure such as the guiding rod and the guiding hole, the guiding rail assembly and the guiding groove assembly, and the guiding tube, the movement of the floating body structure 23 is limited, ensuring the operation stability of the floating body structure 23.

In the above embodiments, the floating body structure 23 having a magnetic property is realized by arranging a permanent magnet on a surface or inside of the floating body structure 23, and the aim to make the floating body structure 23 charged is realized, which is easy to realize and manufacture.

In another embodiment, the floating body structure 23 may be provided with an extension member, the permanent magnet is arranged on the extension member. For example, the floating body structure 23 is provided with an elongated arm, and the permanent magnet is arranged on the elongated arm.

In the above embodiments, the magnetic detecting device 24 is a Hall sensor or a reed switch. By the sensing effect of the Hall sensor or the reed switch on the floating body structure 23 with magnetic property, the liquid level monitoring on the water tank 11 of the water filter 1 is effectively realized.

In the embodiments of the present disclosure, the floating body structure 23 is a columnar structure. The average density of the floating body structure 23 is less than the density of water. A cavity is arranged in the floating body structure 23. One end of the floating body structure 23 facing toward a bottom of the water tank 11 is configured to be open, so that one end of the cavity facing toward the bottom of the water tank 11 is communicated with the water filter 1.

By arranging the cavity in the floating body structure 23, the material consumed for the fabrication of the floating body structure 23 is reduced, decreasing the average density of the floating body structure 23, and ensuring the effective operation of the floating body structure 23 to serve as an alarm.

The alarm assembly 3 in the embodiments of the present disclosure may be an audible alarm device, a visual alarm device, or an audible and visual alarm device, which may use a LED lamp, other light generating device or a graphic indicating device to send a visual alarm signal, and may use a buzzer, a horn, or other device capable of making sound to send an audible alarm signal.

In addition, the alarm assembly 3 of the present disclosure exists in the related art, the specific circuit structure of the alarm assembly 3 in the related art can be used for reference.

The preset height in the embodiment of the present disclosure refers to the liquid level in the water level 11 of the water filter 1 when the filter element of the water filter 1 is blocked, namely, the alarm height.

In addition, the liquid level detecting device 2 of the present disclosure may adopt other manners. For example, an ultrasonic ranging sensor, a light ranging sensor, or a pressure sensor is adopted to detect the liquid level in the water tank 11. Or, a capacitor pole piece is arranged at the preset height of the water tank 11, and the liquid level is determined by detecting a capacitance between the liquid level and the capacitor pole piece.

What is claimed is:

1. A liquid level alarm device for a water filter, comprising an alarm assembly and a liquid level detecting device; wherein
the alarm assembly is electrically connected to the liquid level detecting device arranged in a water tank of the water filter, the alarm assembly is arranged on the water tank; the liquid level detecting device is configured to, in condition that a liquid level in the water tank rises to a preset height send a liquid level warning signal to drive the alarm device to send an alarm signal.

2. The liquid level alarm device for the water filter according to claim 1, wherein the liquid level detecting device comprises a first electrode and a second electrode, the second electrode is arranged at a warning liquid level of the water tank, the first electrode is arranged on a position of the water tank not lower than the second electrode, the first electrode and the second electrode are electrically connected to a power source and the alarm assembly, respectively;
in condition that the liquid level in the water tank reaches the warning liquid level, the first electrode and the second electrode are both in contact with water and conductive to drive the alarm assembly to send the alarm signal.

3. The liquid level alarm device for the water filter according to claim 1, wherein the liquid level detecting device comprises a floating body structure having a magnetic property and a magnetic detecting device, the floating body structure is arranged in the water tank, the magnetic detecting device is correspondingly arranged at a warning liquid level;
the magnetic detecting device is configured to, in condition that the liquid level in the water tank reaches the warning liquid level, detect a magnetic signal of the floating body structure and drive the alarm assembly to send the alarm signal.

4. The liquid level alarm device for the water filter according to claim 3, wherein the floating body structure further comprises a guiding structure for limiting the floating body structure to move along the vertical direction.

5. The liquid level alarm device for the water filter according to claim 4, wherein the guiding structure comprises a guiding rod fixedly arranged in the water tank, and a guiding hole corresponding to the guiding rod and arranged on the floating body structure, the guiding rod and the guiding hole are arranged along the vertical direction, and the floating body structure is sleeved on the guiding rod.

6. The liquid level alarm device for the water filter according to claim 4, wherein the guiding structure comprises a guiding rail assembly and a guiding groove assembly which are fixedly arranged on the water tank and the floating body structure respectively, the guiding rail assembly and the guiding groove assembly are arranged along the vertical direction, and cooperated each other to limit the floating body structure to only move along the vertical direction.

7. The liquid level alarm device for the water filter according to claim 4, wherein the guiding structure comprises a guiding tube fixedly arranged in the water tank along the vertical direction, the floating body structure is arranged in the guiding tube.

8. The liquid level alarm device for the water filter according to claim 1, wherein the liquid level detecting device is an ultrasonic ranging sensor, a light ranging sensor or a pressure sensor.

9. The liquid level alarm device for the water filter according to claim 3, wherein a permanent magnet is arranged on a surface or inside of the floating body structure.

10. The liquid level alarm device for the water filter according to claim 3, wherein the magnetic detecting device is a Hall sensor or a reed switch.
